(19) United States
(12) Patent Application Publication
(10) Pub. No.: US 2012/0074675 A1
(43) Pub. Date: Mar. 29, 2012

(54) COVER FOR AIRBAG APPARATUS

(75) Inventors: Mikine HAYASHI, Kiyosu-shi (JP); Masako Joh, Kiyosu-shi (JP)

(73) Assignee: TOYODA GOSEI CO., LTD., Kiyosu-shi (JP)

(21) Appl. No.: 13/248,240

(22) Filed: Sep. 29, 2011

(30) Foreign Application Priority Data
Sep. 29, 2010 (JP) 2010-218718

(51) Int. Cl. B60R 21/20

(52) U.S. Cl. 280/728.3

(57) ABSTRACT

A cover for an airbag apparatus with a lateral line portion of a tear line partitioning regions on a cover main body located near a decorative part. The cover main body part having the tear line is resin-molded using a soft film having a shape corresponding to the decorative part as an insert. The cover main body part is fractured along the tear line when inflation pressure of the airbag is applied thereto, so that a plurality of lid parts corresponding to the regions is formed. Each lid part opens about a connection portion to a remaining part of the cover main body part, which portion serves as a hinge portion. On a backside of the cover main body part, at least a portion of the part corresponding to the decorative part is provided with a bore portion.

### BACKGROUND OF THE INVENTION

1. Field of the Invention

The invention relates to a cover that covers an airbag apparatus mounted to a vehicle such as automobile, and more particularly, to a cover for an airbag apparatus having a tear line (fracture-expected portion) to be fractured by an airbag and a decorative part such as emblem.

2. Related Art

In vehicles such as automobiles, it is necessary to protect a driver from shock when the shock is applied from the front due to a front end collision. Accordingly, a steering wheel configuring a part of a steering apparatus has been adopted in which an airbag apparatus is assembled in a pad of the steering wheel.

In addition, as a cover for the airbag apparatus, a cover has been known which has a cover main body part covering the airbag from a driver side and a rigid decorative part fixed to the cover main body part from the driver side. The decorative part is used to improve the designs of the cover for an airbag apparatus and the steering wheel and includes an emblem, for example.

The cover main body part is provided with a tear line (fracture-expected portion) that divides the cover main body part into a plurality of regions. Accordingly, when inflation pressure of the airbag is applied, the cover main body part is fractured along the tear line, so that a plurality of lid parts corresponding to the regions is formed. Each lid part is opened (rotated) about a connection portion to the remaining part of the cover main body part, which portion serves as a hinge portion. At this time, any one of the lid parts is opened (rotated) with accompanied by the emblem.

As an aspect of the tear line, as shown in Patent Document 1, a part of the tear line includes a lateral line portion that divides the cover main body part into upper and lower regions. The lateral line portion is provided at a position that is distant at an interval from an outer edge (a side distant from a center of an emblem) of the emblem regarding the up-down direction, when seen from the front side. A part adjacent to the tear line (lateral line portion) of the cover main body part is highly deformed due to the high inflation pressure of an airbag. At this time, when the decorative part is located adjacent to the tear line (lateral line portion), the high stress is also applied to the decorative part, so that when the cover main body part is fractured along the tear line (lateral line portion), the decorative part of rigid resin may fall out or may be split.
[Patent Document 1] Japanese Unexamined Utility Model Publication No. Hei 1-81351

When the lateral line portion is provided at a more downward side than the emblem, the upper region becomes larger as the lateral line portion is distant downward from the decorative part. When the cover main body part is fractured along the tear line, the upper lid part corresponding to the upper region is formed. However, the upper lid part also becomes larger as the upper region is enlarged. When the upper lid part is upward opened (rotated) about the hinge portion serving as a support point, with accompanied by the decorative part, a rotating radius (a distance between the lateral line portion and the hinge portion) of the upper lid part is increased.

Accordingly, when the airbag is inflated and the cover main body part is thus fractured along the tear line while a driver takes a posture highly different from a normal posture, for example a slouching posture at which the driver leans the upper body toward the steering wheel, the upper lid part may get stuck with a jaw and the like of the driver during the upward opening (rotation), so that the upper lid part is restrained from being further opened upward. In this case, the upper lid part becomes an obstacle to the upward inflation of the airbag, thereby influencing the deployment performance of the airbag.

Contrary to the above, the lateral line portion is provided at a more upward side than the emblem, the lower region becomes larger as the lateral line portion is distant upward from the decorative part. When the cover main body part is fractured along the tear line, the lower lid part corresponding to the lower region is formed. However, the lower lid part also becomes larger as the lower region is enlarged. When the lower lid part is downward opened (rotated) about the hinge portion serving as a support point, with accompanied by the decorative part, a rotating radius (a distance between the lateral line portion and the hinge portion) of the lower lid part is increased.

Accordingly, when the airbag is inflated and the cover main body part is thus fractured along the tear line while a driver takes a slouching posture at which the driver leans the upper body toward the steering wheel, the lower lid part may get stuck with a chest and the like of the driver during the downward opening (rotation), so that the lower lid part is restrained from being further opened downward. In this case, the lower lid part becomes an obstacle to the downward inflation of the airbag, thereby influencing the deployment performance of the airbag.

The above problems are not limited to the airbag apparatus that is provided to the steering wheel and thus protects the driver from the shock, and may be also commonly caused in an airbag apparatus for an assistant driver's seat and a side airbag apparatus.

### SUMMARY OF THE INVENTION

The invention has been made to solve the above problems. An object of the invention is to provide a cover for an airbag apparatus capable of suppressing a lid part from becoming an obstacle to inflation of an airbag and thus appropriately deploying the airbag even when a passenger takes a posture coming close to the airbag.

First aspect of the invention provides a cover for an airbag apparatus including:

a cover main body part that covers, from a passenger side, an airbag of an airbag apparatus mounted to a vehicle;

a decorative part that is made of a soft film and is stacked on a passenger side of the cover main body part; and

a tear line that divides the cover main body part into a plurality of regions, at least a portion of the tear line being provided at a position overlapping with an outer edge of the decorative part or at a position adjacent to the decorative part, when seen from a front side,

wherein the cover main body part having the tear line is resin-molded by using a soft film having a shape corresponding to the decorative part as an insert, so that the decorative part and the cover main body part are integrally formed,

wherein the cover main body part is fractured along the tear line when inflation pressure of the airbag is applied thereto, so that a plurality of lid parts corresponding to the regions is formed,

wherein each lid part is opened about a connection portion to a remaining part of the cover main body part, which portion serves as a hinge portion, and

wherein on a backside of the cover main body part, at least a portion of the part corresponding to the decorative part is provided with a bore portion.

Here, the remaining part of the cover main body part is a part except for a lid part of the cover main body part.

According to the above configuration, at a normal state in which the shock is not applied to the vehicle, the airbag is not inflated and is covered from the passenger side by the cover main body part. In addition, by the decorative part stacked to the passenger side of the cover main body part, it is possible to improve the design of the cover for an airbag apparatus.

When the shock is applied to the vehicle and the airbag is thus inflated and deployed due to the shock, a part adjacent to the tear line of the cover main body part is applied with the high inflation pressure of the airbag and is thus highly deformed. At this time, since the condition that ‘at least a portion of the tear line is located at a position that overlaps with the outer edge of the emblem or at a position coming close to the decorative part, when seen from the front side’ is satisfied, the decorative part is also applied with the high stress.

However, according to the invention of Claim 1, the cover main body part having the tear line is resin-molded by using the soft film having a shape corresponding to the decorative part as an insert, so that the decorative part and the cover main body part are integrally formed. Accordingly, even when the high stress is applied, as described above, the decorative part made of the soft film is just bent together with the cover main body part and does not fall out or is not split well.

When the cover main body part is fractured along the tear line due to the inflation pressure of the airbag, a plurality of lid parts corresponding to the regions is formed to the cover main body part. Each lid part is opened (rotated) about a connection portion to the remaining part of the cover main body part, which portion serves as a hinge portion. At this time, a lid body of the lid parts, which is integrated with the decorative part, is opened (rotated) with accompanied by the decorative part.

Here, since at least a portion of the tear line satisfies the above condition, the distance between the corresponding portion of the tear line and the hinge portion in the lid part integrated with the decorative part is shorter than the related art. In other words, the rotating radius of the lid part integrated with the decorative part is shorter than the related art.

Accordingly, when the airbag is inflated and the cover main body part is thus fractured along the tear line while the passenger takes a posture coming close to the airbag apparatus, it is difficult for the lid part integrated with the decorative part to contact and interfere with the passenger while the lid part is opened (rotated) about the hinge portion serving as a support point.

Also, in the cover main body part, at least a portion of the part corresponding to the decorative part is provided with the bore portion, so that the portion is thinned and apt to be elastically deformed. Therefore, even when the lid part integrated with the decorative part contacts and thus interferes with the passenger while it is opened (rotated), as described above, the lid part is elastically deformed, so that the lid part can get out between the remaining part of the cover main body part and the passenger and continue to be opened (rotated).

As a result, the lid part, which is opened (rotated) with accompanied by the decorative part, is difficult to become an obstacle to the inflation of the airbag, so that it is difficult to influence the deployment performance of the airbag.

In second aspect of the invention, the tear line may include a lateral line portion that divides at least a portion of the cover main body part into upper and lower regions and is provided at a position overlapping with the outer edge of the decorative part regarding an up-down direction or at a position coming close to the decorative part from the up-down direction, when seen from the front side. The cover main body part may be fractured along the tear line due to the inflation pressure of the airbag, so that an upper lid part corresponding to the upper region and a lower lid part corresponding to the lower region are formed.

According to the above configuration, when the cover main body part is fractured along the tear line due to the inflation pressure of the airbag, the cover main body part is formed with the upper lid part corresponding to the upper region and the lower lid part corresponding to the lower region. The upper lid part is upward opened (rotated) about the connection portion to the remaining part of the cover main body part, which portion serves as a hinge portion, and the lower lid part is downward opened (rotated) about the connection portion to the remaining part of the cover main body part, which portion serves as a hinge portion. At this time, the lid body of the lid parts, which is integrated with the decorative part, is opened (rotated) with accompanied by the decorative part.

Here, the lateral line portion is located at a position that overlaps with the outer edge of the decorative part regarding the up-down direction or at a position coming close to the decorative part from the up-down direction, when seen from the front side, the lid part integrated with the decorative part has the upper-lower distance between the lateral line portion and hinge portion shorter than the related art.

Accordingly, when the airbag is inflated and the cover main body part is thus fractured along the tear line while the passenger takes a posture coming close to the airbag apparatus, it is difficult for the lid part integrated with the decorative part to contact and interfere with the passenger while the lid part is opened (rotated) about the hinge portion serving as a support point.

Also, in the cover main body part, at least a portion of the part corresponding to the decorative part is thinned due to the bore portion and thus apt to be elastically deformed. Therefore, even when the lid part integrated with the decorative part contacts and thus interferes with the passenger while it is opened (rotated) in the up-down direction, as described above, the lid part is elastically deformed, so that the lid part can get out between the remaining part of the cover main body part and the passenger and continue to be opened (rotated).

In third aspect of the invention, the lateral line portion may be provided at a position that overlaps with a lower portion of the outer edge of the decorative part or at a position coming close to the decorative part from the lower thereof. The upper lid part, which is formed as the cover main body part is fractured along the tear line, may be upward opened about the connection portion to the remaining part of the cover main body part, which portion serves as a hinge portion.

According to the above configuration, since the lateral line portion of the tear line is located at the lower side of the decorative part, the upper lid part, which is formed as the cover main body part is fractured along the tear line, is upward opened (rotated) about the connection portion to the remaining part of the cover main body part, which portion serves as a hinge portion, with accompanied by the decorative part.

Here, the lateral line portion is located at a position that overlaps with a lower side of the outer edge of the decorative part or at a position coming close to the decorative part from the lower side thereof, when seen from the front side, the upper lid part has the distance between the lateral line portion and hinge portion shorter than the related art.

Accordingly, when the airbag is inflated and the cover main body part is thus fractured along the tear line while the passenger takes a posture coming close to the airbag apparatus, it is difficult for the passenger to contact and interfere with a part adjacent to the upper side of the cover main body part while the upper lid part is upward opened (rotated) upward.

Also, in the upper lid part integrated with the decorative part, at least a portion of the part corresponding to the decorative part is thinned due to the bore portion and thus apt to be elastically deformed. Therefore, even when the upper lid part contacts and thus interferes with the passenger while it is upward opened (rotated), the upper lid part is elastically deformed, so that the upper lid part can get out between the remaining part of the cover main body part and the passenger and continue to be opened (rotated) upward.

As a result, the upper lid part, which is upward opened (rotated) with accompanied by the decorative part, is difficult to become an obstacle to the upward inflation of the airbag.

In fourth aspect of the invention, the airbag apparatus may be mounted in a pad part of a steering wheel that is steered by a driver.

The driver may take a posture coming close to the airbag apparatus, for example a posture at which the jaw of the driver is positioned adjacent to the upper surface of the pad part and the forehead is close to the upper side of the rim part (steering wheel part) of the steering wheel, i.e., a slouching posture at which the driver leans the upper body forward. Under such circumstance, when the airbag is inflated and the cover main body part is thus fractured along the tear line, the upper lid part is upward opened (rotated) about the connection portion to the remaining part of the cover main body part, which portion serves as a hinge portion.

At this time, in the upper lid part, the distance between the lateral line portion and hinge portion are shorter than the related art. Hence, when the upper lid part is upward opened (rotated), it is difficult for the upper lid part to contact and interfere with the jaw and the like of the driver.

Also, in the upper lid part integrated with the decorative part, at least a portion of the part corresponding to the decorative part is thinned due to the bore portion and thus apt to be elastically deformed. Therefore, even when the upper lid part contacts and thus interferes with the jaw and the like of the driver and the like while it is upward opened (rotated), the upper lid part is elastically deformed, so that the upper lid part can get out between the remaining part of the cover main body part and the passenger and continue to be opened (rotated) upward.

According to the cover for an airbag apparatus of the invention, even when the passenger takes a posture coming close to the airbag apparatus, it is possible to suppress the lid part from becoming an obstacle to the inflation of the airbag and thus to appropriately deploy the airbag.

### BRIEF DESCRIPTION OF THE DRAWINGS

FIG. 1 is a front view of a steering wheel having an airbag apparatus attached thereto, to which a cover for an airbag apparatus according to an illustrative embodiment of the invention is applied.

FIG. 2 is an enlarged sectional view of a pad part taken along a line X-X of FIG. 1.

FIG. 3 is an enlarged sectional view of a Y part of FIG. 1.

FIG. 4 is a partially enlarged front view showing a decorative part and a lateral line part of FIG. 1.

FIG. 5 is a partially enlarged sectional view showing an aspect with the dashed-two dotted line, in which a cover main body part is fractured along a tear line and upper and lower lid parts of FIG. 1 are thus opened (rotated) by inflation pressure of an airbag.

FIG. 6 is a schematic side view showing a relation between a driver and a steering wheel having an airbag apparatus attached thereto when the driver takes a posture coming close to the airbag apparatus.

### DETAILED DESCRIPTION OF THE PREFERRED EMBODIMENTS

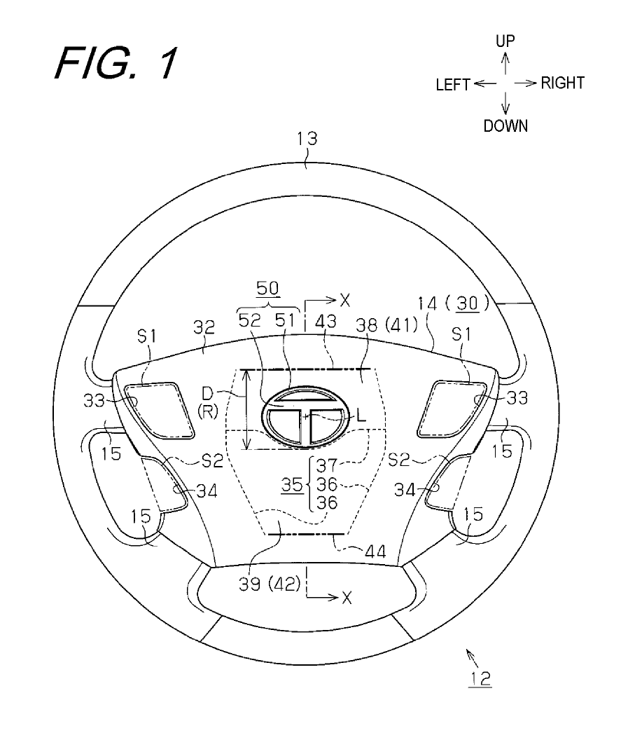

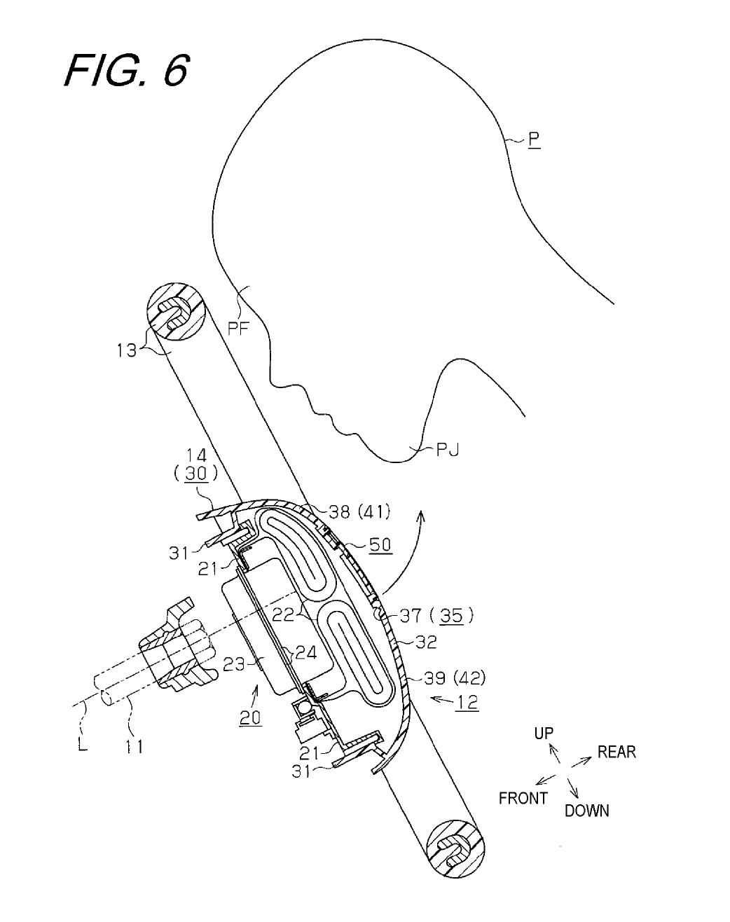

Hereinafter, an illustrative embodiment in which a cover for an airbag apparatus of the invention is applied to a steering wheel having an airbag apparatus attached thereto, which airbag apparatus is mounted to a vehicle, will be described with reference to the drawings. As shown in at least one of FIGS. 1 and 6, a steering shaft 11 that is rotated about a rotating axis line L is obliquely provided at a front of a driver's seat of a vehicle (at a left side in FIG. 6) so that it is higher at the driver's seat (at a right side in FIG. 6). A steering wheel 12 is integrally and rotatably mounted to a rear end of the steering shaft 11. The steering wheel 12 has a rim part (which is also referred to as a steering wheel part and a ring part) 13, a pad part 14 and a spoke part 15. The rim part 13 is a member that is gripped and steered by a driver, and has a substantial ring shape about the steering shaft 11 (refer to FIG. 1). Since the steering shaft 11 is inclined as described above, the rim part 13 is also inclined so that it is closer to the driver's seat at a lower part thereof (refer to FIG. 6).

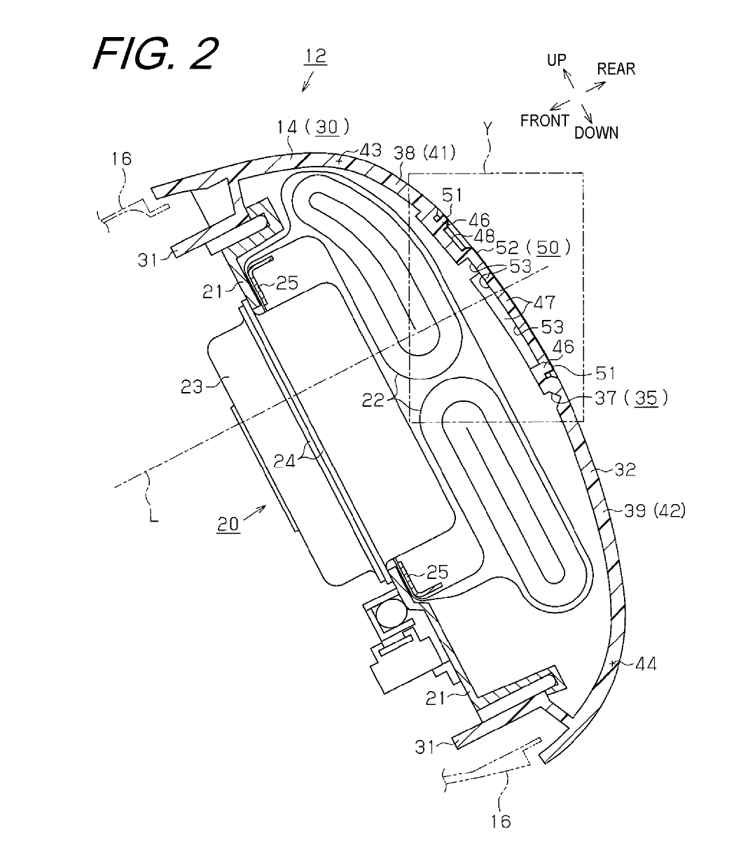

The pad part 14 is disposed in a space surrounded by the rim part 13. A front side of the pad part 14 is configured by a lower cover 16 (refer to the dashed-two dotted line in FIG. 2). The spoke part 15 is provided at a plurality of positions between the rim part 13 and the pad part 14.

In this illustrative embodiment, the respective parts of the steering wheel 12 are described, based on the rotating axis line L of the steering shaft 11. A direction parallel with the rotating axis line L is referred to as a ‘front-rear direction’ of the steering wheel 12, and a direction, along which the steering wheel 12 stands up, of directions parallel with a surface orthogonal to the rotating axis line L, is referred to as an ‘up-down direction.’ Accordingly, the front-rear and up-down directions of the steering wheel 12 are slightly inclined with respect to a front-rear direction (horizontal direction) and an up-down direction (vertical direction) of a vehicle.

In order to specify the circumferential positions of the rim part 13, ‘up’, ‘down’, ‘left’ and ‘right’ are defined, based on a state in which the vehicle travels straightly, i.e., a neutral state, in this illustrative embodiment.

As shown in FIG. 2, the pad part 14 is provided therein with an airbag apparatus 20 so as to protect a driver P (refer to FIG. 6) from shock due to the front end collision and the like by an airbag 22. The airbag apparatus 20 has a bag holder 21 and the airbag 22 and an inflator 23 that are respectively assembled to the bag holder 21.

The inflator 23 accommodates therein a gas generating agent (not shown) for generating gas for inflation. The inflator 23 is engaged to the bag holder 21 at flanges 25 protruding from an outer circumference thereof. In the meantime, regarding the inflator 23, an inflator that fractures a partition wall of a high pressure gas cylinder having high pressure gas filled therein by gunpowder and the like and thus ejects the gas for inflation may be used instead of the inflator using the gas generating agent.

The airbag 22 is made of flexible fabric and the like and is disposed with being folded at a rear side of the inflator. The airbag 22 has an opening at a front end thereof and is fixed to the bag holder 21 together with the inflator 23 by a ring plate 25 disposed on a periphery of the opening.

As shown in at least one of FIGS. 1 and 2, the airbag apparatus 20 is covered by a cover 30 for an airbag apparatus having a cylindrical wall part 31, a cover main body part 32 and a decorative part 50.

The cylindrical wall part 31 is substantially parallel with the rotating axis line L, surrounds the folded airbag 22 and is engaged to the bag holder 21. The cover main body part 32 is to cover a rear side of the airbag 22 by blocking the cylindrical wall part 31 from the rear side (driver P). The cover main body part 32 is formed to be larger in the upper-lower and left-right direction than a size required to block the cylindrical wall part 31. The cover main body part 32 is provided with holes 33 and notches 34 for disposing various switches S1, S2 at its more leftward and rightward parts than the cylindrical wall part 31. The cylindrical wall part 31 and the cover main body part 32 are integrally formed of soft material such as soft resin and the like.

The cover main body part 32 is provided with a tear line 35 (fracture-expected part) that is fractured as the inflation pressure of the airbag 22 is applied thereto. The tear line 35 is formed by providing a recess having a V-shaped section and the like to the cover main body part 32 from a backside (front side) thereof. The tear line 35 is thinner and has lower strength than any other portions of the cover main body part 32, so that the cover main body part 32 is fractured along the tear line 35 by the inflation pressure of the airbag 22.

The tear line 35 includes two longitudinal line portions 36, which extend in the substantially up-down direction at positions opposed to each other in the left-right direction with a central portion of the cover main body part 32 being interposed therebetween, and a lateral line portion 37, which extends in the substantially horizontal direction and connects the longitudinal line portions 36, and has a substantial H shape when seen from the driver P side. Although the lateral line portion 37 is horizontal at left and right sides thereof, it has a convex shape at the center thereof that protrudes downward.

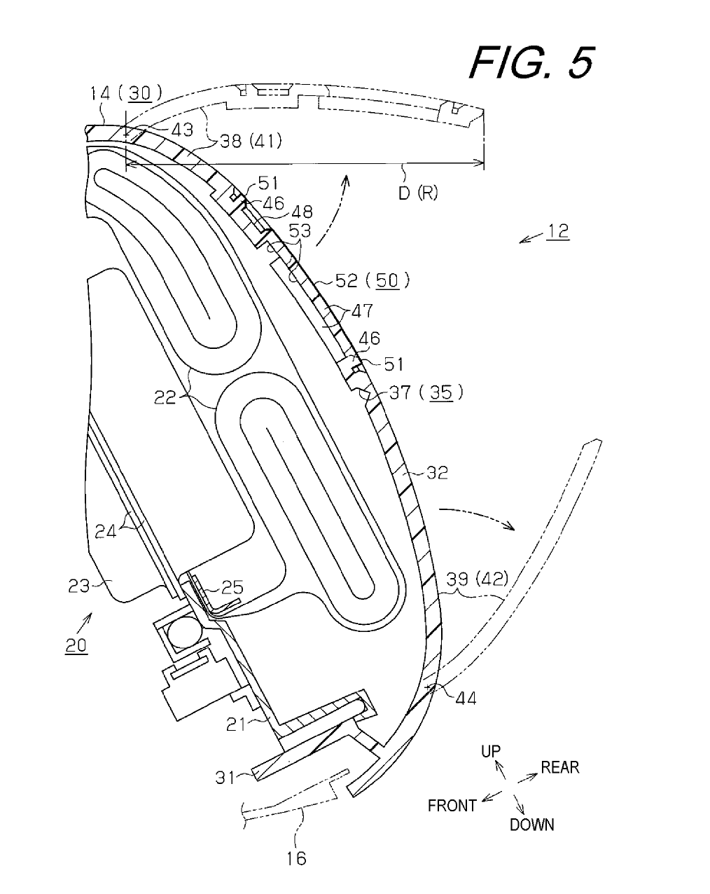

A part of the cover main body part 32, which is a rearward side of the airbag 22, is divided into a pair of upper and lower regions by the tear line 35. In order to distinguish from each other, in this illustrative embodiment, a region that is located at a more upward side than the lateral line portion 37 is referred to as an ‘upper region 38’ and, a region that is located at a more downward side than the lateral line portion 37 is referred to as an ‘lower region 39.’ When the cover main body part 32 is fractured along the tear line 35, the cover main body part 32 is formed with an upper lid part 41 corresponding to the upper region 38 and a lower lid part 42 corresponding to the lower region 39, as shown with the dashed-two dotted line in FIG. 5.

As shown in at least one of FIGS. 1 and 5, the upper lid part 41 and the lower lid part 42 can be opened (rotated) about a connection portion to a remaining part of the cover main body part 32, which portion serves as a hinge portion. Here, the remaining part of the cover main body part 32 is a part except for the upper lid part 41 and the lower lid part 42 of the cover main body part 32. More specifically, the upper lid part 41 can be upward opened (rotated) about a portion between upper end portions of the longitudinal line portions 36, which portion serves as a hinge portion 43. The lower lid part 42 can be downward opened (rotated) about a portion between lower end portions of the longitudinal line portions 36, which portion serves as a hinge portion 44.

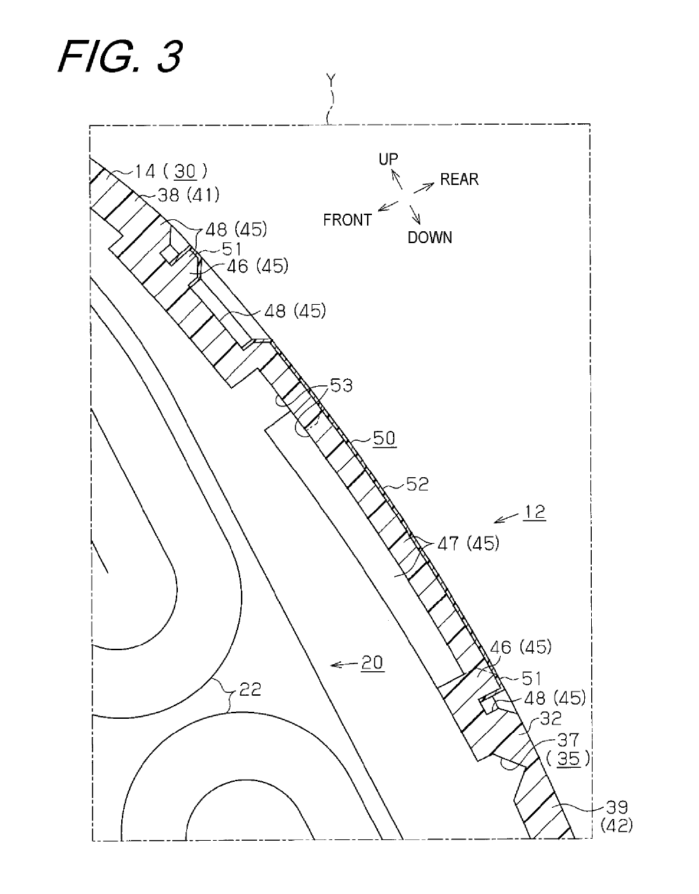

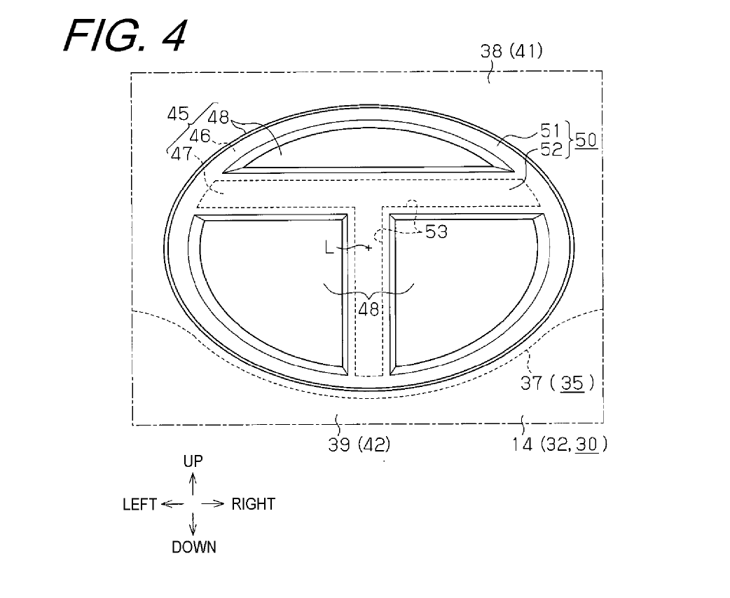

As shown in at least one of FIGS. 3 and 4, a substantially central part of the cover main body part 32, which is adjacent to the upper of the lateral line portion 37 in the upper region 38, is provided with a concavo-convex portion 45. The concavo-convex portion 45 includes a ring base portion 46 having an annular shape of a substantially long elliptical shape in the lateral direction, an emblem base part 47 positioned in an area surrounded by the ring base portion 46 and a recessed portion 48 at a periphery of the ring base portion 46 or between the ring base portion 46 and the emblem base portion 47. Here, the emblem base portion 47 has a ‘T’ shape, when seen from the front side. However, the emblem base portion may form the other shapes. The emblem base portion 47 is connected to the ring base portion 46 at a plurality of locations.

The decorative part 50 is to improve an outward quality (design) of the cover main body part 32 of the cover 30 for an airbag apparatus, and further the steering wheel 12, and is separately formed from the cover main body part 32. More specifically, the decorative part 50 is formed by sequentially stacking a metal deposition layer and a luster layer on a backing film made of a soft film with an adhesive layer being interposed therebetween and then stacking a transparent surface protection layer on the luster layer with an adhesive layer being interposed therebetween. The surface protection layer is to increase the weather resistance of the decorative part 50. Like this, the decorative part 50, which is stacked and integrated to the cover main body part 32 from the driver P side, is soft, so that it does not fall out or is not split well, compared to the related decorative part entirely made of rigid resin. The metal deposition layer and the luster layer of the decorative part 50 generate metallic luster.

The decorative part 50 has a ring portion 51, which is stacked on the ring base portion 46 of the concavo-convex portion 45 from the driver P side, and an emblem portion 52, which is stacked on the emblem base portion 47 from the driver P side. The ring portion 51 has a shape corresponding to the ring base portion 45, i.e., an annular shape of a substantially long elliptical shape in the lateral direction. A lower portion of an outer edge of the ring portion 51 comes close to the lateral line portion 37 of the tear line 35 from the upper. In other words, the lateral line portion 37 is provided at a position coming close to the decorative part 50 from the lower thereof.

The emblem portion 52 indicates an emblem, a mark and the like and has a shape (‘T’ shape) corresponding to the emblem base portion 47. The emblem portion 52 is connected to the ring portion 51 at a plurality of locations. Contrary to the cover main body part 32, the decorative part 50 is not formed with the tear line 35.

On the backside of the cover main body part 32 (upper region 38), at least a portion of the part corresponding to the decorative part 50 (a portion corresponding to the emblem portion 52 in this illustrative embodiment) is provided with a bore portion 53. The portion of the cover main body part 32 to which the bore portion 53 is provided is thinner than the other parts having no bore portion and thus is apt to be elastically deformed.

The cover 30 for an airbag apparatus having the above configuration is formed by a film insert method including a film processing process and an injection molding process.

In the film processing process, a soft film sheet having an adhesive layer, a metal deposition layer, a luster layer, an adhesive layer and a surface protection layer stacked on a backing film is pre-formed. In the pre-forming, the film sheet is softened by heating the film sheet. The softened film sheet is pressed by a mold for forming the decorative part 50, so that the air between the film sheet and the mold gets out and a state close to the vacuum is thus formed. By the vacuum state, the film sheet is closely contacted to a surface of the mold, so that the film sheet is given with a shape corresponding to the decorative part 50. Then, unnecessary parts are trimmed (cut) from the film sheet that has been pre-formed as described above. Here, the part that has remained after trimming the film sheet is referred to as ‘soft film.’

In the injection molding process, the soft film, which has been given with the shape corresponding to the decorative part 50 through the film processing process, becomes an insert and is set in a cavity (molding space) of a mold for injection molding. After clamping the mold, the melted resin is filled in the cavity by the injection and then cured (solidified), so that the cover 30 for an airbag apparatus having the decorative part 50 and the cover main body part 32 integrated thereto is obtained.

As described above, the steering wheel 12 having the airbag apparatus 20 of this illustrative embodiment attached thereto is configured.

In the steering wheel 12 having the airbag apparatus 20 attached thereto, as shown in FIG. 2, at a normal state in which the shock resulting from the front end collision is not applied to the vehicle from the front, the gas for inflation is not supplied to the airbag 22 from the inflator 23 and the airbag 22 is covered with being folded by the cover main body part 32 from the rear side.

In addition, the design of the cover main body part 32 and further the cover 30 for an airbag apparatus or steering wheel 12 is improved by the metallic luster, which is generated by the metal deposition layer and the luster layer of the decorative part 50 stacked on the cover main body part 32 from the driver P side.

When the shock is applied to the vehicle from the front due to the front end collision and the like, the gas for inflation is supplied to the airbag 22 from the inflator 23 due to the shock. When the airbag 22 is inflated and deployed by the gas for inflation, the inflation pressure of the airbag 22 is applied to the cover 30 for an airbag apparatus.

A part of the cover main body part 32, which is adjacent to the tear line 35 including the lateral line portion 37, is applied with the high inflation pressure of the airbag 22 and is thus highly deformed. At this time, since the condition (i) that ‘the lateral line portion 37 is located at a position coming close to the decorative part 50 from the lower thereof, when seen from the front side’ is satisfied, the decorative part 50 is also applied with the high stress.

However, in this illustrative embodiment, the cover main body part 32 having the tear line 35 is resin-molded by using the soft film having a shape corresponding to the decorative part 50, as an insert, and the cover 30 for an airbag apparatus is thus formed, so that the decorative part 50 and the cover main body part 32 are integrally formed. Accordingly, even when the high stress is applied, as described above, since the decorative part 50 is just bent together with the cover main body part 32 made of the soft material such as soft resin and the like, it does not fall out or is not split well.

When the cover main body part 32 is fractured along the tear line 35 due to the inflation pressure of the airbag, the pair of upper and lower lid parts 41, 42 corresponding to the regions 38, 39 divided by the tear line 35 (left and right longitudinal line portions 36 and lateral line portion 37) is formed to the cover main body part 32.

As shown with the dashed-two dotted line in FIG. 5, the upper lid part 41 is upward opened (rotated) about the hinge portion 43 serving as a support point, which is the connection portion to the remaining part of the cover main body part 32. In addition, as shown with the dashed-two dotted line in FIG. 5, the lower lid part 42 is opened (rotated) in the downward direction, i.e., in the opposite direction to the upper lid part 41 about the hinge portion 44 serving as a support point, which is the connection portion to the remaining part of the cover main body part 32. At this time, since the lateral line portion 37 of the tear line 35 is located at the lower side of the decorative part 50, the upper lid part 41, which is formed as the cover main body part 32 is fractured along the tear line 35, is upward opened (rotated) with accompanied by the decorative part 50.

The upper and lower lid parts 41, 42 are opened (rotated) in the opposite direction to each other, as described above, so that an opening is formed therebetween. When the driver P takes a normal posture at which the driver leans his back against the backrest of the driver's seat, the airbag 22 is circularly inflated and deployed rearward through the opening. The airbag 22 having been circularly inflated and deployed is interposed between the driver P who is being inclined forward due to the shock of the front end collision and the airbag apparatus 20, so that the driver P is restrained from being inclined forward and is thus protected from the shock.

Here, since the lateral line portion 37 satisfies the above condition (i), a distance D between the lateral line portion 37 and the hinge portion 43 in the upper lid part 41 integrated with the decorative part 50 is shorter than the related art. In other words, a rotating radius R of the upper lid part 41 about the hinge portion 43 serving as a support point is shorter than the related art.

Accordingly, when the airbag 22 is inflated and the cover main body part 32 is thus fractured along the tear line 35 while the driver P takes a posture coming close to the airbag apparatus 20, it is difficult for the upper lid part 41 integrated with the decorative part 50 to contact and interfere with the driver P while the upper lid part is opened about the connection portion to the remaining part of the cover main body part 32, which portion serves as the hinge portion 43.

In the meantime, the ‘posture at which the driver comes close to the airbag apparatus 20’ is a posture at which the upper body is forward bent, for example a lower end of the jaw PJ of the driver P is positioned adjacent to the upper surface of the pad part 14 (cover main body part 32 of the cover 30 for an airbag apparatus) and the forehead PF is adjacent to the upper side of the rim part 13 of the steering wheel 12, as shown in FIG. 6.

Also, in this illustrative embodiment, a portion of the cover main body part 32 (upper region 38) corresponding to the emblem portion 52 of the decorative part 50 is provided with the bore portion 53, so that the portion is thinned and thus apt to be elastically deformed. Therefore, even when the upper lid part 41 integrated with the decorative part 50 contacts and thus interferes with the jaw PJ and the like of the driver P while it is upward opened (rotated), the upper lid part is elastically deformed, so that the upper lid part can get out between the remaining part of the cover main body part 32 and the jaw PJ and the like and continue to be upward opened (rotated).

As a result, the upper lid part 41, which is upward opened (rotated) with accompanied by the decorative part 50, is difficult to become an obstacle when the airbag 22 is circularly inflated upward.

According to the above illustrative embodiment, the following operational effects can be realized.

(1) As the decorative part 50 that is stacked on the cover main body part 32 from the driver P side, the material made of soft film is used. The cover main body part 32 having the tear line 35 is resin-molded by using the soft film having a shape corresponding to the decorative part 50, as an insert, so that the cover 30 for an airbag apparatus having the decorative part 50 and the cover main body part 32 integrated thereto is formed (refer to FIG. 3).

Accordingly, although the cover 30 for an airbag apparatus has the different structure from the related cover for an airbag apparatus in which the decorative part made of rigid resin is separately provided from the cover main body part and is fixed to the cover main body part from the driver side by the welding and the like, the cover 30 for an airbag apparatus has the substantially same outward appearance as the related cover for an airbag apparatus.

In addition, even when the high stress is applied to the decorative part 50, it is difficult for the decorative part 50 to fall out or to be split.

Accordingly, the degree of design freedom of the tear line 35, which divides the cover main body part 32 into the regions 38, 39 is increased.

(2) As the degree of design freedom is increased, as described above, the portion (lateral line portion 37) of the tear line 35 is provided at the position adjacent to the decorative part 50 from the lower thereof. By doing so, in the upper lid part 41 integrated with the decorative part 50, the distance D between the lateral line portion 37 and the hinge portion 43 is shorter than the related distance (refer to FIG. 5).

Accordingly, for a case where the airbag 22 is inflated and the cover main body part 32 is thus fractured when the driver P takes a posture coming close to the airbag apparatus 20, it is possible to suppress the upper lid part 41 from contacting and interfering with the jaw PJ and the like of the driver P when the upper lid part 41 is upward opened (rotated) about the hinge portion 43 serving as a support point with accompanied by the decorative part 50.

As a result, it is possible to suppress the upper lid part 41, which is upward opened (rotated) with accompanied by the decorative part 50, from becoming an obstacle to the upward inflation of the airbag 22 and thus influencing the deployment performance of the airbag 22 that intends to be circular.

(3) On the backside of the upper lid part 41 integrated with the decorative part 50, the part corresponding to the emblem portion 52 of the decorative part 50 is provided with the bore portion 53, so that the part is thinned and the upper lid part 41 is thus elastically deformed easily (refer to FIG. 5).

Accordingly, even when the upper lid part 41 contacts and thus interferes with the jaw PJ and the like of the driver P while it is opened (rotated) with accompanied by the decorative part 50, the upper lid part 41 is elastically deformed, so that the upper lid part can get out between the remaining part of the cover main body part 32 and the jaw PJ and the like and continue to be opened (rotated).

In the meantime, the invention can be also embodied as the following illustrative embodiments.

<Regarding the Cover Main Body Part 32>

The tear line 35 may enable the cover main body part 32 to be fractured in an arbitrary direction such as vertical direction, horizontal direction and the like. Within the range satisfying such condition, the tear line 35 may be changed into a different shape from the above illustrative embodiment, for example a substantial T shape.
The tear line 35 may not be necessarily continuous such as a recess. For example, the recesses, each of which is linear or dot-shaped, may be intermittently provided to entirely form a linear shape.
The sectional shape of the tear line 35 having a T shape may be changed into a U shape, a substantially rectangular shape and the like, for example.
The tear line 35 may divide the cover main body part 32 into two or more regions and may be fractured by the inflation pressure of the airbag 22, thereby forming the lid parts corresponding to the regions. Also in this case, the tear line 35 on the cover main body part 35 is set at a position that overlaps with the outer edge of the decorative part 50 or at a position close to the decorative part 50, when seen from the front side.
The lateral line portion 37 may be provided to a position adjacent to the decorative part 50 from the upper thereof, when seen from the front side. In this case, since the lateral line portion 37 of the tear line 35 is positioned at the upper side of the decorative part 50, the lower lid part 42, which is formed as the cover main body part 32 is fractured along the tear line 35, is downward opened (rotated) about the connection portion to the remaining part of the cover main body part 32, which is the hinge portion 44, with accompanied by the decorative part 50.

In addition, in the upper lid part 41 integrated with the decorative part 50, the distance between the lateral line portion 37 and the hinge portion 44 is shorter than the related art, from the above positional relation between the lateral line portion 37 and the decorative part 50.

Accordingly, for a case where the airbag 22 is inflated and the cover main body part 32 is thus fractured along the tear line 35 when the driver P takes a posture coming close to the airbag apparatus 20, it is possible to suppress the lower lid part 42 integrated with the decorative part 50 from contacting and interfering with the chest and the like of the driver P when the lower lid part 42 is downward opened (rotated) about the hinge portion 43 serving as a support point.

Thus, also in this case, it is possible to suppress the lower lid part 42, which is opened (rotated) with accompanied by the decorative part 50, from becoming an obstacle to the downward inflation of the airbag 22 and thus influencing the deployment performance of the airbag 22 that intends to be circular, as the above illustrative embodiment.
The part on the backside of the cover main body part 32 to which the bore portion 53 is provided may be at least a portion of the part corresponding to the decorative part 50. Accordingly, the bore portion 53 may be provided to the ring base portion 46 on which the ring portion 51 is stacked, instead of the emblem base portion 47 or in addition to the emblem base portion.
A portion (lateral line portion 37 in the above illustrative embodiment) of the tear line 35 may be provided to the part that overlaps with the outer edge of the decorative part 50, when seen from the front side.

<Regarding the Decorative Part 50>
The decorative part 50 may be configured by a plurality of parts. For example, the ring portion 51 and the emblem portion 52 of the decorative part 50 may be independent of each other.

<The Others>
The cover for an airbag apparatus of the invention is not limited to the vehicle and can be applied to the steering wheel of a steering apparatus in the other vehicles such as airplane, ship and the like. In this case, the vehicle is not limited to the automobile and includes a variety of industrial vehicles.
The invention is not limited to the steering wheel having the airbag apparatus mounted thereto, which protects the passenger (driver P) on the driver's seat from the shock, and can be applied to a cover for an airbag apparatus of an assistant passenger's seat, a cover for a side airbag apparatus and the like.

In this case, not only the driver but also the passenger may be protected by the airbag apparatus. Also, the lid part that is opened (rotated) with accompanied by the decorative part may be brought into contact with (interfere with) the other parts of the passenger in addition to the jaw or chest.

What is claimed is:

1. A cover for an airbag apparatus comprising:
a cover main body part that covers, from a passenger side, an airbag of an airbag apparatus mounted to a vehicle;
a decorative part that is made of a soft film and is stacked on a passenger side of the cover main body part; and
a tear line that divides the cover main body part into a plurality of regions, at least a portion of the tear line being provided at a position overlapping with an outer edge of the decorative part or at a position adjacent to the decorative part, when seen from a front side,
wherein the cover main body part having the tear line is resin-molded by using a soft film having a shape corresponding to the decorative part as an insert, so that the decorative part and the cover main body part are integrally formed,
wherein the cover main body part is fractured along the tear line when inflation pressure of the airbag is applied thereto, so that a plurality of lid parts corresponding to the regions is formed,
wherein each lid part is opened about a connection portion to a remaining part of the cover main body part, which portion serves as a hinge portion, and
wherein on a backside of the cover main body part, at least a portion of the part corresponding to the decorative part is provided with a bore portion.

2. The cover for an airbag according to claim 1, wherein the tear line comprises a lateral line portion that divides at least a portion of the cover main body part into upper and lower regions and is provided at a position overlapping with the outer edge of the decorative part regarding an up-down direction or at a position coming close to the decorative part from the up-down direction, when seen from the front side, and
wherein the cover main body part is fractured along the tear line due to the inflation pressure of the airbag, so that an upper lid part corresponding to the upper region and a lower lid part corresponding to the lower region are formed.

3. The cover for an airbag according to claim 2, wherein the lateral line portion is provided at a position that overlaps with a lower portion of the outer edge of the decorative part or at a position coming close to the decorative part from the lower thereof, and
wherein the upper lid part, which is formed as the cover main body part is fractured along the tear line, is upward opened about the connection portion to the remaining part of the cover main body part, which portion serves as a hinge portion.

4. The cover for an airbag according to claim 3, wherein the airbag apparatus is mounted in a pad part of a steering wheel that is steered by a driver.
